(19) United States
(12) Patent Application Publication
(10) Pub. No.: US 2011/0283237 A1
(43) Pub. Date: Nov. 17, 2011

(54) INFORMATION PROCESSING APPARATUS, CONTROL METHOD THEREOF, AND STORAGE MEDIUM

(75) Inventor: Takeshi Hayakawa, Kawasaki-shi (JP)

(73) Assignee: CANON KABUSHIKI KAISHA, Tokyo (JP)

(21) Appl. No.: 13/100,150

(22) Filed: May 3, 2011

(30) Foreign Application Priority Data
May 17, 2010 (JP) 2010-113436

(51) Int. Cl. G06F 3/048

(52) U.S. Cl. 715/835

(57) ABSTRACT

An apparatus includes a storage unit configured to, if an instruction to interrupt an operation of a bookbinding application that sets print setting information is received, store operation contents of the bookbinding application at a point of interruption, a creation unit configured to create a shortcut icon to reproduce the operation contents at the point of interruption, and a reproduction unit configured to reproduce the operation contents at the point of interruption based on the stored operation contents at interruption, if the shortcut icon is designated.

### BACKGROUND OF THE INVENTION

1. Field of the Invention

The present invention relates to a program capable of interrupting an operation of a bookbinding application and restarting the bookbinding application from a status where it is interrupted.

2. Description of the Related Art

Personal computers are provided with a function to link to a desired application therein, which facilitates activation of the application. To execute the function, a shortcut icon (i.e. shortcut) for the application can be created. Each personal computer runs a lot of applications, and thereby a large number of shortcuts corresponding to the applications are displayed on the screen of the computer. Such shortcuts usually include those that are unnecessary or do not operate correctly.

Japanese Patent Application Laid-Open No. 2002-259010 discusses a technique for creating a shortcut for not every application but the one that has been activated at least a predetermined times. Japanese Patent Application Laid-Open No. 2002-259010 also discusses a technique for deleting a shortcut that has not been used for a predetermined period of time.

In the techniques discussed in Japanese Patent Application Laid-Open No. 2002-259010, a shortcut of an application is created at the timing of an activation of the application. Hence, the shortcuts created in Japanese Patent Application Laid-Open No. 2002-259010 are only useful to simplify the activations of the corresponding applications.

Thus, for example, if the application is interrupted and terminated in the middle of execution, the conventional shortcut of the application is not useful to easily restart the application from the state where it was terminated.

### SUMMARY OF THE INVENTION

According to an aspect of the present invention, an apparatus includes a storage unit configured to, if an instruction to interrupt an operation of a bookbinding application that sets print setting information is received, store operation contents of the bookbinding application at a point of interruption, a creation unit configured to create a shortcut icon to reproduce the operation contents at the point of interruption, and a reproduction unit configured to reproduce the operation contents at the point of interruption based on the stored operation contents at interruption, if the shortcut icon is designated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus.

FIG. 2 illustrates a software configuration of each function module of an information processing apparatus.

FIG. 3 illustrates an activation sequence of a bookbinding application.

FIG. 4 illustrates an example of an Extensible Markup Language (XML) file to enable activation of a bookbinding application.

FIG. 5 illustrates examples of parameters to activate a bookbinding application.

FIG. 6 is a flowchart illustrating termination of a bookbinding application.

FIG. 7 is a flowchart illustrating creation of a shortcut.

FIG. 8 illustrates XML formats saved at creation of a shortcut.

FIG. 9 is a flowchart illustrating activation of a bookbinding application using a shortcut.

FIG. 10 illustrates an example of a user interface (UI) of a bookbinding application.

FIG. 11 illustrates an example of a UI to terminate a bookbinding application.

FIG. 12 illustrates an XML format saved at creation of a shortcut.

FIG. 13 is a flowchart illustrating creation of a shortcut.

FIG. 14 is a flowchart illustrating recreation of a shortcut.

### DESCRIPTION OF THE EMBODIMENTS

Various exemplary embodiments, features, and aspects of the invention will be described in detail below with reference to the drawings.

The present disclosure is based on the following technique. An information processing apparatus of the present disclosure includes an electronic document writer that converts data generated by a general application into electronic document file, and a bookbinding application for laying out the electronic document file.

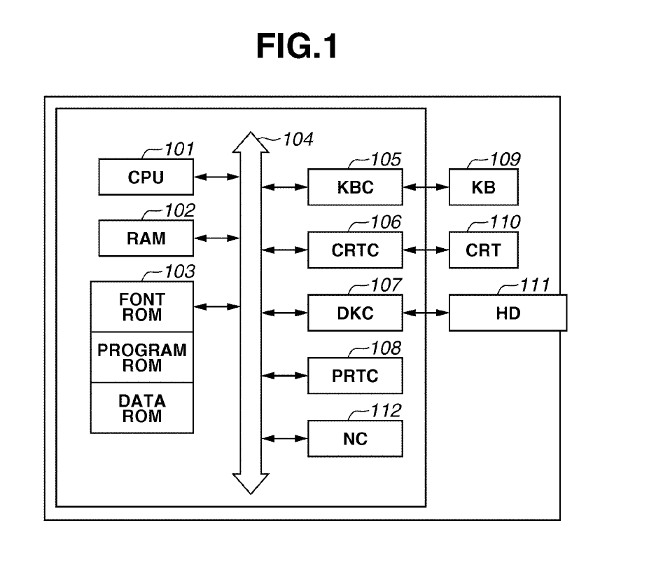

FIG. 1 is a block diagram illustrating a configuration of an information processing apparatus applicable to a first exemplary embodiment of the present invention.

In FIG. 1, a central processing unit (CPU) 101 executes programs loaded from a read only memory (ROM) 103 or a hard disk 111 to a random access memory (RAM) 102, and implements the sequences of flowcharts, which will be described below. The programs to be loaded include an operating system (OS) , general applications, a bookbinding application, and the like.

The RAM 102 functions as a main memory or a work area of the CPU 101. A keyboard controller (KBC) 105 controls a key input from a keyboard 109 or a pointing device (not illustrated) . A cathode ray tube (CRT) controller (CRTC) 106 controls displays on a CRT display 110. A disk controller (DKC) 107 controls accesses between the apparatus and a hard disk (HD) 111, a floppy disk (FD) , and the like that store a boot program, various applications, font data, user files, edited files, which are described below, for example. A print controller (PRTC) 108 controls signal exchanges between the apparatus and a printer connected thereto. A network controller (NC) 112 is connected to a network, and executes a communication control process with another apparatus connected to the network.

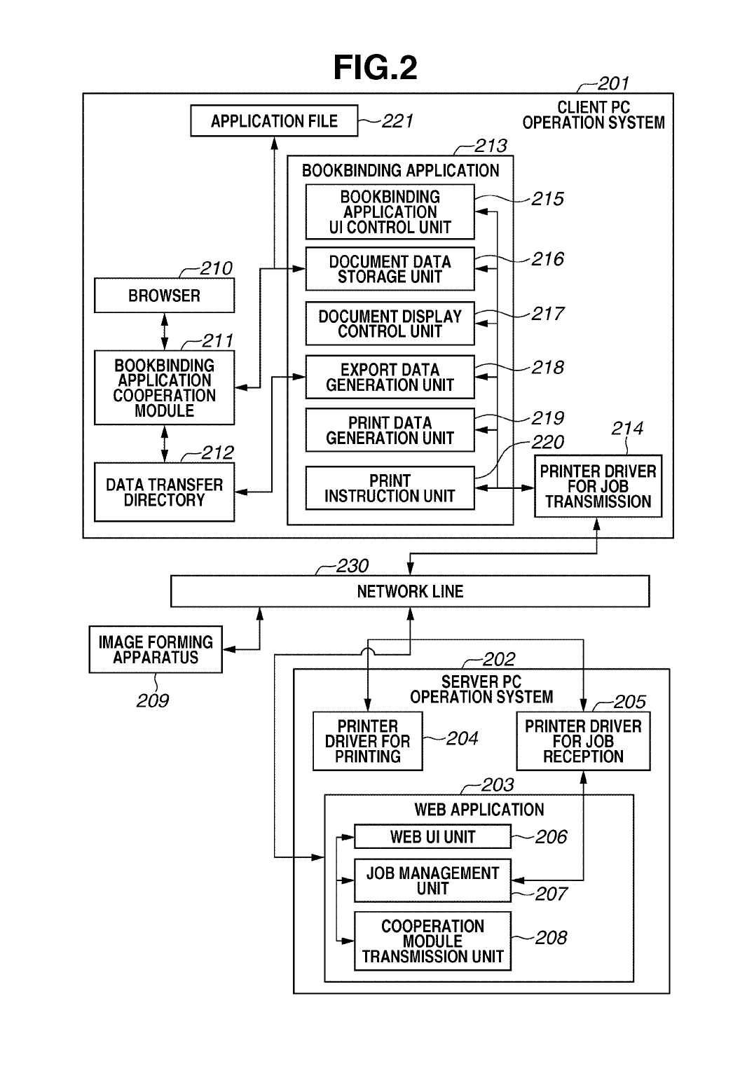

FIG. 2 illustrates a software configuration of each function module of a personal computer applicable to the present exemplary embodiment.

A client PC 201 and a server PC 202 each are the information processing apparatus described in FIG. 1, and have the same hardware configuration. The client PC 201 can communicate with the server PC 202 and an image forming apparatus 209 via a network line 230. The network line 230 may be of any communication type such as local area network (LAN) and wide area network (WAN).

The server PC 202 has an internal configuration as follows. The server PC 202 includes a Web application 203, a printer driver for printing 204, and a printer driver for job reception 205. The Web application 203 includes a Web UI unit 206 and a job management unit 207 as modules. The Web UI unit 206 manages and generates screens on browsers displayed by a Web application. The job management unit 207 manages jobs related to the Web application 203. The jobs managed by the job management unit 207 can be each displayed on the browser and printed.

When printing is executed, the printer driver for printing 204 transmits a print job to the image forming apparatus 209. The job management unit 207 manages a print job transmitted from the printer driver for job reception 205. A cooperation module transmission unit 208 can transmit a bookbinding application cooperation module 211 to the client PC 201. The bookbinding application cooperation module 211 is a program operating in the client PC 201.

The client PC 201 has an internal configuration as follows. The client PC 201 includes a browser 210, the bookbinding application cooperation module 211, a data transfer directory 212, the bookbinding application 213, and a printer driver for job transmission 214 incorporated therein. The browser 210 displays Web pages managed by the Web UI unit 206. The bookbinding application cooperation module 211 is downloaded from the cooperation module transmission unit 208 of the server PC 202 via the network using a browser. The bookbinding application cooperation module 211 can activate the bookbinding application 213.

The data transfer directory 212 is not a program but a file management area in the client PC 201. The data transfer directory 212 maybe any data management area that applications can use on the OS. The data transfer directory 212 includes data that can be used by the bookbinding application cooperation module 211 and the bookbinding application 213. The printer driver for job transmission 214 is a printer driver which receives a print instruction from the bookbinding application 213 and transmits a print job to the printer driver for job reception 205 via the network line 230.

The bookbinding application 213 has an inner configuration as follows. An application file 221 is a printable electronic file containing texts and/or images. The application file 221 is read by the bookbinding application 213.

The bookbinding application 213 reads the application file 221, sets print setting information for printing, and instructs printing. The bookbinding application 213 includes modules 215 to 220 which are corporative to one another in the bookbinding application 213 for free communication of data and control instructions therebetween. A bookbinding application UI control unit 215 controls the UI of the bookbinding application 213. The UI can receive instructions to print from a user and to generate export data that is not to be printed.

A document data storage unit 216 stores document data to be displayed on the application file 221 and the bookbinding application UI control unit 215. A document display control unit 217 controls the display of the document data by the bookbinding application 213. In other words, the document display control unit 217 controls thumbnails to be displayed to a user, and a thumbnail corresponding to a page layout of the print setting information set by the user.

An export data generation unit 218 generates data to be exported. More specifically, the bookbinding application 213 has a printing function and a function to export data used by the bookbinding application 213 as an image file. When the bookbinding application 213 executes the export function, the export data generation unit 218 generates data to be exported. A print data generation unit 219 converts the data used by the bookbinding application 213 into a format appropriate for printing to generate print data. Upon receiving a print instruction, a print instruction unit 220 transmits the print data to the printer driver for job transmission 214.

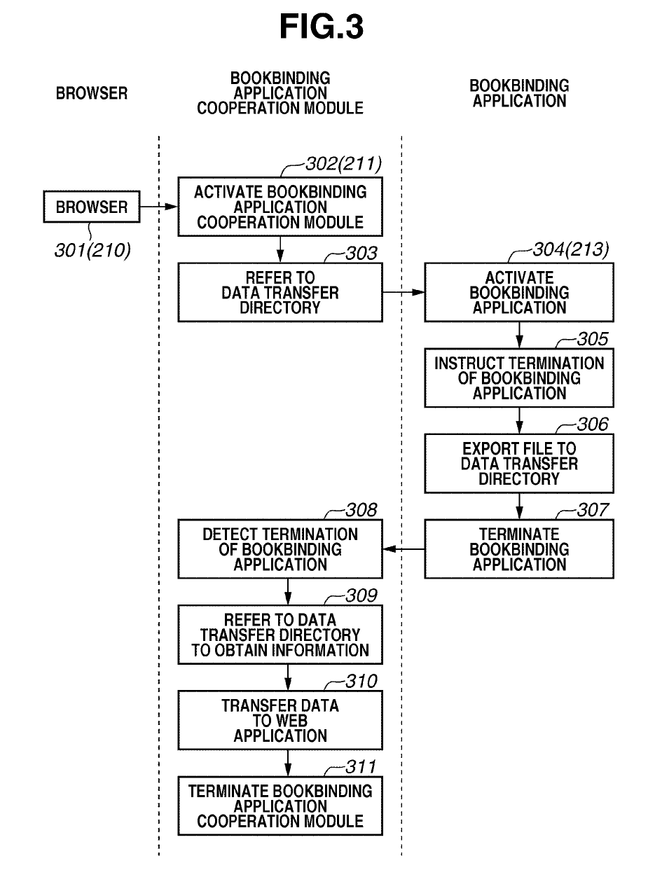

FIG. 3 illustrates an activation sequence of a bookbinding application applicable to the present exemplary embodiment. FIG. 3 illustrates a sequence to activate and complete a bookbinding application in the client PC 201.

In step 301, the browser displays a screen generated by the Web UI unit 206 of the Web application 203. In step 302, at receipt of an instruction from a user, the browser downloads the bookbinding application cooperation module 211 from the cooperation module transmission unit 208 of the server PC 202 to the client PC 201, and executes (activates) the bookbinding application cooperation module 211.

In step 303, the bookbinding application cooperation module 211 refers to the data transfer directory 212. The data transfer directory 212 contains electronic data required to activate the bookbinding application 213 and downloaded from the server PC 202 by the browser. The electronic data required to activate the bookbinding application 213 includes a portable document format (PDF) file to be printed and an XML file to activate the bookbinding application.

In step 303, the bookbinding application cooperation module 211 refers to the data transfer directory 212, and retrieves the XML file to activate the bookbinding application. Then in step 304, the bookbinding application cooperation module 211 activates the bookbinding application 213. At the activation, the bookbinding application 213 uses the XML file stored in the data transfer directory 212.

In step 305, the bookbinding application 213 receives an instruction to terminate the application from a user, and performs a termination process. The bookbinding application 213 is used by the user between the steps 304 and 305.

In step 306, the bookbinding application 213 exports a target file to the data transfer directory 212. The data to be exported contains PDF data to be used by the Web application 203 and an XML file to be used by the bookbinding application cooperation module 211.

In step 307, the bookbinding application 213 terminates the bookbinding application 213. In step 308, the bookbinding application cooperation module 211 detects the termination of the bookbinding application 213.

In step 309, the bookbinding application cooperation module 211 refers to the XML file in the data transfer directory 212, and reads the information in the XML file. The XML information contains a status written by the bookbinding application 213. The status may be a normal termination or termination by interruption of the application, and completion of PDF file generation, for example.

In step 310, the bookbinding application cooperation module 211 transfers the PDF data to the Web application 203. In step 311, the process of the bookbinding application cooperation module 211 terminates. As described above, the sequence to activate and terminate the bookbinding application 213 is performed in the client PC 201.

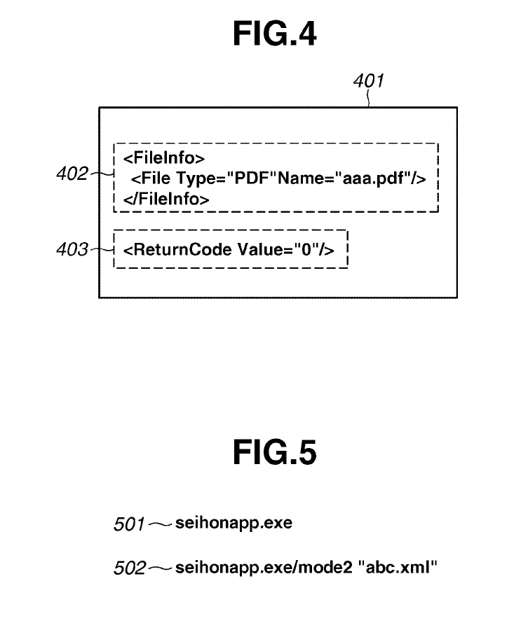

FIG. 4 illustrates an example of an XML file to enable activation of a bookbinding application

The bookbinding application 213 uses an XML file 401 to activate the bookbinding application 213. The XML information 401 contains information required to activate the bookbinding application 213. Other markup language that defines meaning and structure of data may be used instead of XML. The XML file 401 is downloaded to the data transfer directory 212 according to an instruction from the browser 210. The XML file 401 includes an area 402 for describing information about a file to be processed by the bookbinding application 213, and an area 403 in which the bookbinding application 213 describes a status.

The area 402 describes a file path to a PDF file to be edited by the bookbinding application 213. The PDF file edited by the bookbinding application 213 is determined by the browser 210 according to an instruction from a user. The file path to the PDF file described in the area 402 corresponds to the data transfer directory 212. The area 403 has description of a status of the bookbinding application 213. The status is written when the bookbinding application 213 terminates, and is transferred to the bookbinding application cooperation module 211. Thus, the information described in the area 403 is not used at the activation of the bookbinding application.

FIG. 5 illustrates examples of parameters to activate a bookbinding application. The bookbinding application 213 can change its operation at activation by designating the parameter following a name of an executable file. An executable file 501 is used when the bookbinding application is activated in a normal mode.

Alternatively, the bookbinding application 213 may be activated in corporation with the Web application 203. In this case, the bookbinding application 213 is activated using a combined parameter 502 of an executable file name and a print job to be processed as an argument. As a result, the bookbinding application 213 is activated in a corporation mode that is different from the normal mode.

In the case where the bookbinding application 213 is activated in the corporation mode, the steps 305 to 307 in FIG. 3 are performed when the bookbinding application 213 terminates. The description of /mode2“abc.xml” in the parameter 502 is the parameter of the present exemplary embodiment. In the parameter 502, the name of an XML file is the key information. The XML file name indicates the XML file illustrated in FIG. 4 and downloaded to the data transfer directory 212.

To activate an bookbinding application in the corporation mode, for example, the UI of the bookbinding application cooperation module 211 may have a button to activate the bookbinding application, so that an instruction from a user via the button causes the bookbinding application to be activated in the corporation mode.

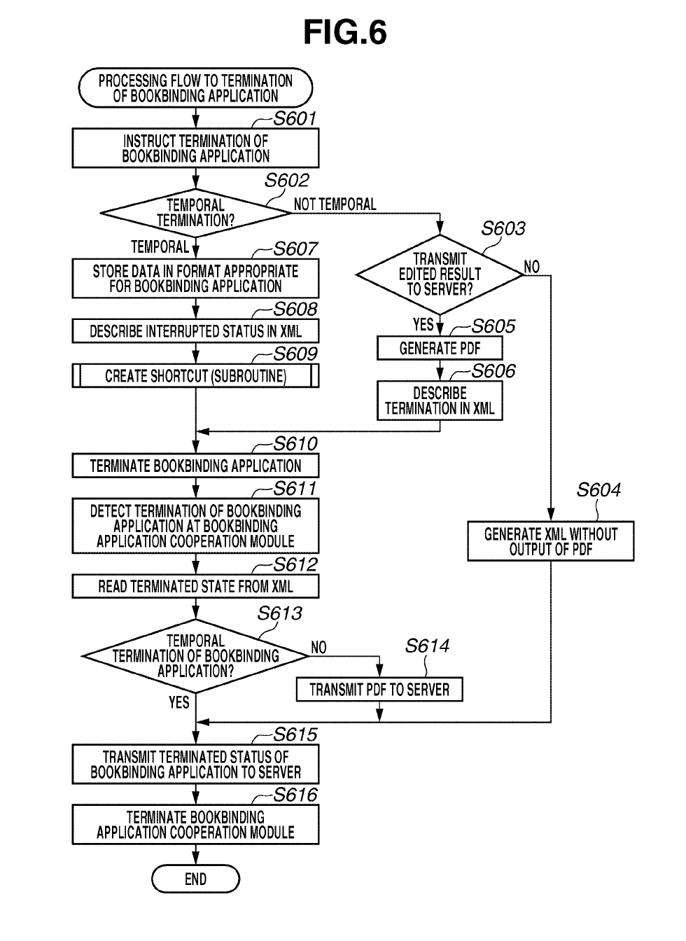

A flowchart for processing to create a shortcut icon is described, the creation being a feature of the present exemplary embodiment. FIG. 6 is a flowchart illustrating termination of the bookbinding application. The procedure illustrated in the flowchart is implemented in the client PC 201. The client PC 201 has the configuration illustrated in FIG. 1, and has a program code of software to implement the flowchart stored in a storage medium. A CPU (or micro-processing unit (MPU)) of a system or an apparatus reads the program code stored in the storage medium, and executes the processing in the flowchart.

In step S601, the bookbinding application 213 receives an instruction to terminate the bookbinding application 213 from a user and starts a termination process thereof. In step S602, the bookbinding application 213 determines whether the termination of the bookbinding application 213 is temporal interruption of the operation or not. More specifically, at the termination of the bookbinding application 213, the bookbinding application 213 displays a UI that can inquires whether the termination is temporal interruption of the operation or not, so that bookbinding application 213 performs the determination in step S602 according to an instruction to the inquiry from a user via the UI.

When the bookbinding application 213 determines the termination of the bookbinding application 213 is not temporal (NO in step S602), in step S603, the bookbinding application 213 determines whether to transmit a result edited by the bookbinding application (i.e., edited PDF) to the Web application 203. For example, when a user designates a 2-in-1 format using the bookbinding application, the bookbinding application edits a target file according to the print setting information. As a result, a PDF file is prepared through imposition that makes data for two pages printed on one surface of a sheet.

The bookbinding application 213 determines whether to transmit the prepared PDF data to the Web application 203. A physical destination of the transmission from the Web application 203, which is operating in the server PC 202, is the job management unit 207 of the server PC 202. In step S603, the bookbinding application 213 displays a UI that can accept an instruction whether to transmit the PDF edited by the bookbinding application to the server, and makes a determination in step S603 according to an instruction from a user via the UI. The determination in step S603 may be included in the UI to be displayed in step S602 as options, and the UI may be displayed at the timing of step S602.

When the bookbinding application 213 determines not to transmit the file to the server (NO in step S603) , in step S604, the bookbinding application 213 only updates the XML file 401, because the data (PDF file) to be transmitted to the server PC is no longer necessary.

In contrast, in step S603, when the bookbinding application 213 determines to transmit the PDF file as the edited result of the bookbinding application to the server (YES in step S603) , in step S605, the bookbinding application 213 generates a PDF file as data to be transmitted to the server PC 202. More specifically, PDF data prepared by imposition as described above is generated. In step S606, the bookbinding application 213 updates the XML file 401, in particular, the information in the area 403 of the XML file 401. The bookbinding application 213 describes a status (a code indicating termination of the application) to be transmitted to the bookbinding application cooperation module 211 in the area 403.

In step S602, when the bookbinding application 213 determines the termination of the bookbinding application 213 is temporal (YES in step S602), in step S607, the bookbinding application 213 stores a file for reproducing the state of the application at the temporal interruption when the operation is restarted. More specifically, the bookbinding application 213 stores a file containing description about the operation contents at the temporal interruption. The file of the operation contents is given a unique file extension appropriate for the bookbinding application 213.

In step S608, the bookbinding application 213 updates the XML file 401. In particular, the information in the area 403 of the XML file 401 is updated. The bookbinding application 213 describes the status transmitted to the bookbinding application cooperation module 211 in the area 403. Unlike the processing in step S606 where the code indicating termination is written, in step S608, a code indicating interruption is written

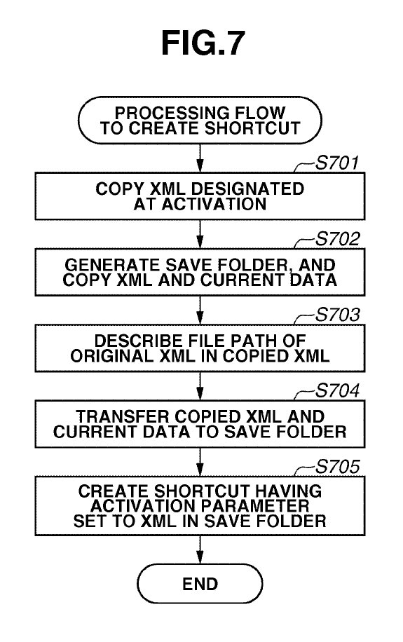

In step S609, the bookbinding application 213 creates a shortcut. A detail flow of the shortcut creation will be described below with reference to FIG. 7. In step S609, after the bookbinding application 213 creates a shortcut, the process proceeds to step S610. In step S610, the bookbinding application 213 terminates itself. The termination in step S610 means termination of program execution unit (which is generally referred to as process) of the bookbinding application 213.

In step S611, the bookbinding application cooperation module 211 detects the termination of the bookbinding application 213. The processing instep S611 corresponds to step 308 in FIG. 3. The bookbinding application cooperation module 211 detects the termination of the bookbinding application 213 by monitoring the program execution unit of the bookbinding application 213. In step S612, the bookbinding application cooperation module 211 refers to the data transfer directory 212 to read the contents in the XML file 401, and determines the status where the bookbinding application 213 is terminated based on the contents described in the area 403.

In step S613, the bookbinding application cooperation module 211 determines whether the bookbinding application 213 is terminated by temporal interruption. If the bookbinding application 213 is not terminated by interruption (NO in step S613), then in step S614, the bookbinding application cooperation module 211 transmits the PDF file to the job management unit 207 of the server PC 202. If the bookbinding application 213 is terminated by interruption (YES in step S613) , then in step S615, the bookbinding application cooperation module 211 transmits the terminated status of the bookbinding application 213 to the server PC 202. The terminated status of the application is the one in an interrupted pattern that passes step S607, a normally terminated pattern that passes step S605, or a cancelled pattern that passes step S604. In step S616, the bookbinding application cooperation module 211 terminates the processing thereof.

FIG. 7 is a flowchart describing processing in step S609 in FIG. 6 in detail. In step S701, the bookbinding application 213 copies the XML file designated at the activation of the bookbinding application 213. The XML file corresponds to the XML file 401 in FIG. 4. The sequence designated at the activation is step 304 in FIG. 3, and corresponds to a description of /mode2“abc.xml” in the parameter 502 in FIG. 5.

In step S702, the bookbinding application 213 generates a folder to be saved. The folder can be saved at any location except the data transfer directory 212. It is desirable that the location that is not easily deleted by a user. Examples of the location include a layer where the bookbinding application 213 is installed, and a user directory determined by the OS. In step S703, the bookbinding application 213 adds description of a file path of the original XML file to the XML file copied in step S702.

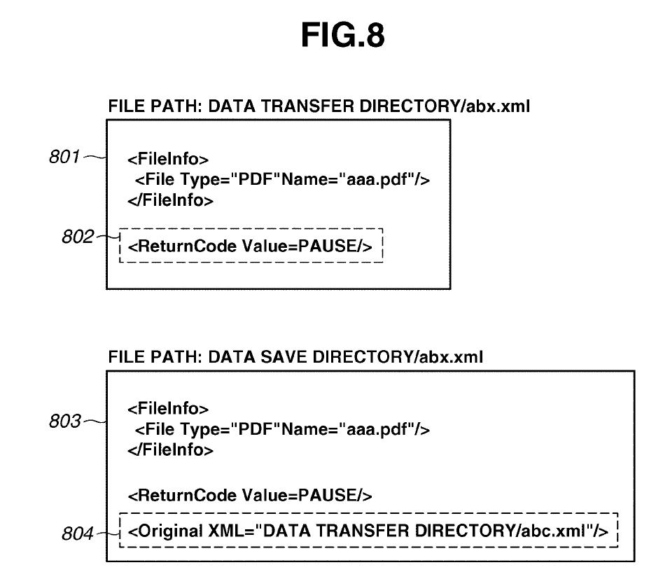

In step S704, the bookbinding application 213 transfers the XML file having the description of the file path of the original XML file added in step 703 to the save folder generated in step S702. The bookbinding application 213 further transfers the data of the current status of the application. The data of the current status is a file storing the operation contents of the bookbinding application 213 till the termination thereof for restart of the operation, the file being generated in step S607. As a result, the save folder stores the XML file (an XML file 803 in FIG. 8) having the description of the file path of the original XML file, and the file having the description of the operation contents of the bookbinding application 213 at the termination thereof.

In step S705, the bookbinding application 213 creates a shortcut. The shortcut is provided with a command to activate the bookbinding application cooperation module 211. In other words, the bookbinding application 213 designates the name of a file to be executed by the bookbinding application cooperation module 211 in the shortcut.

The bookbinding application 213 creates the shortcut so that the shortcut contains a command to automatically activate the bookbinding application 213 at the activation of the bookbinding application cooperation module 211. In the creation, the bookbinding application 213 adds description of a parameter after the designated executable file name of the bookbinding application cooperation module 211 as the parameter 502 in FIG. 5. The parameter designates the XML file (e.g., the XML file 803 in FIG. 8) stored in the save folder in step S704.

FIG. 8 illustrates XML files saved at creation of a shortcut. An XML file 801 is stored in the data transfer directory 212. The bookbinding application 213 adds an interrupted status in step S608 to an area 802 of the XML file 801. The XML file 803 is the file transferred by the bookbinding application 213 to the save folder in step S704.

The XML file 803 contains an area 804 having description of the file path of the original XML file before copying by the bookbinding application 213 in step S703. As described above, the XML file 803 is generated by copying the XML file 801 and describing the file path added in step S703.

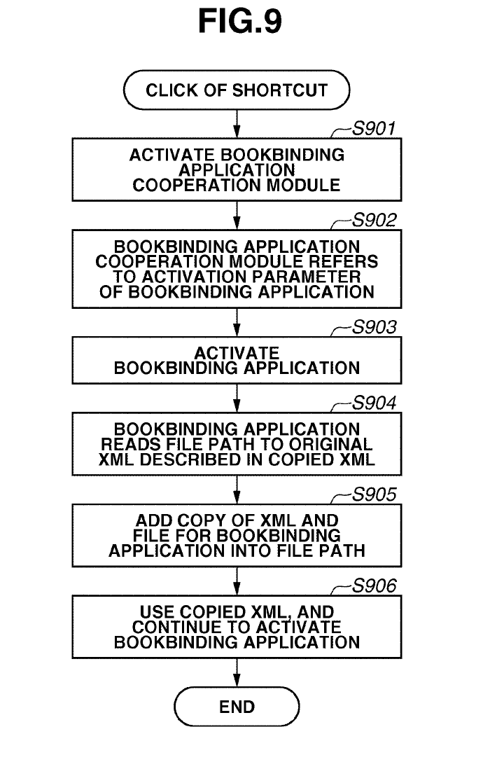

Next, a method for activating the bookbinding application 213 using the created shortcut is described with reference to FIG. 9. FIG. 9 is a flowchart illustrating a program executed by the bookbinding application cooperation module 211 and the bookbinding application 213 when a user clicks the shortcut created in the flowchart in FIG. 6.

In step S901, the client PC 201 executes a program designated by the shortcut in step S705. As described above, the shortcut contains information designating the name of a file to be executed by the bookbinding application cooperation module 211, and hence the bookbinding application cooperation module 211 is activated.

In step S902, the bookbinding application cooperation module 211 refers to link information of the bookbinding application 213 to activate the bookbinding application 213. The link information is the description of the parameter following the name of a file to be executed by the bookbinding application 213 in step S705, the parameter leading to reference to the XML file 803.

In step S903, the bookbinding application cooperation module 211 uses the parameter referred to in step S902, and activates the bookbinding application 213. The activated bookbinding application 213 executes the s steps S904 to S906.

In step S904, the bookbinding application 213 reads the file path to the original XML (i.e., “data transfer directory/abc.xml”) in the area 804 of the XML file 803.

In step S905, the bookbinding application 213 stores copies of the XML file 803 and a file for bookbinding application into the folder at the file path read in step S904. The file for bookbinding application is a file transferred to the save folder in step S704 to be used for restart of the bookbinding application 213.

In step S906, the bookbinding application 213 uses the XML file stored in step S905 to continue the activation of the bookbinding application 213. In other words, by use of the file path “data transfer directory/abc.xml”, the bookbinding application 213 is activated. In this way, the bookbinding application cooperation module 211 and the bookbinding application 213 are activated using the shortcut.

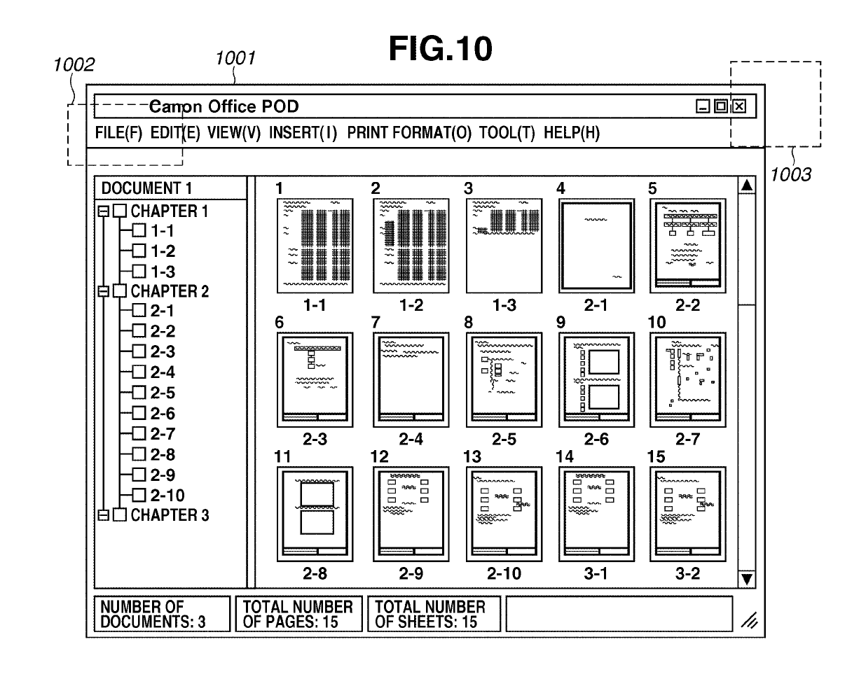

FIG. 10 illustrates an example of a UI of the bookbinding application. When the bookbinding application 213 is activated, a main UI 1001 is displayed. The bookbinding application 213 can be terminated through an operation of a file menu 1002 or an end button 1003. When a user uses the file menu 1002 or the end button 1003 to enter an instruction to terminate the bookbinding application 213, the bookbinding application 213 starts the termination processing flow illustrated in FIG. 6.

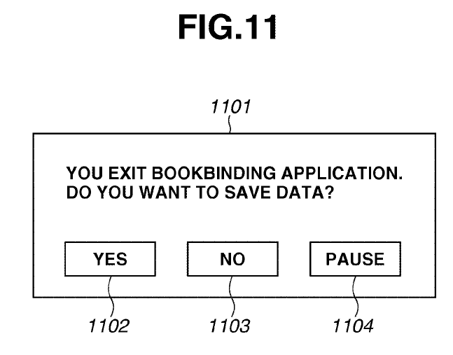

FIG. 11 illustrates an example of a UI to terminate the bookbinding application. At termination, the bookbinding application 213 displays a termination UI 1101. The termination UI 1101 corresponds to the UI through which a user can instruct whether the termination is temporal or not in step S602, and includes buttons 1102 to 1104.

The button 1102 is used to instruct saving of the operation contents and termination of the bookbinding application 213. Pressing of the button 1102 by a user causes the bookbinding application 213 to execute the processing in step S605.

The button 1103 is used to instruct termination of the bookbinding application 213 without saving of the operation contents. Pressing of the button 1103 by a user causes the bookbinding application 213 to execute the processing in step S604.

The button 1104 is used to instruct interruption of the operation of the bookbinding application 213. Pressing of the button 1104 by a user causes the bookbinding application 213 to execute the processing in step S607.

As described above, in the present exemplary embodiment, a shortcut is created when the operation of an application is interrupted. The created shortcut contains link information including description of a parameter to activate the application from the status where the application was interrupted, so that a click of the shortcut enables a user to restart the operation of the application from the status at the point of interruption.

In the first exemplary embodiment, a method of creating a shortcut that enables a restart of the operation of the bookbinding application 213 from the status at the point of interruption thereof, when a user wants to interrupt the operation, is described. If, however, the shortcut is erroneously deleted, restart of the operation cannot be achieved. A second exemplary embodiment provides a method for automatically recreating a shortcut.

The present exemplary embodiment is similar to the first exemplary embodiment with respect to FIGS. 1 to 6 and FIGS. 8 to 11, so that descriptions thereof are not repeated. The second exemplary embodiment includes a further process for activation of the bookbinding application 213 as compared to the first exemplary embodiment.

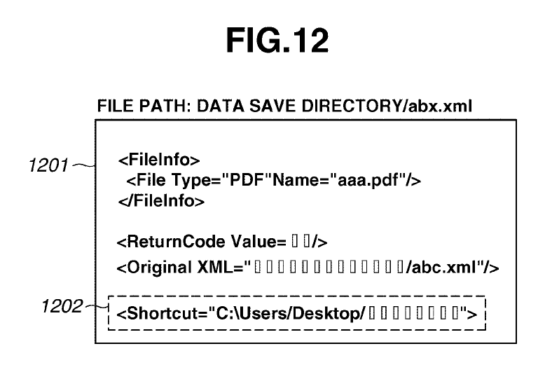

FIG. 12 illustrates an XML file saved at creation of a shortcut. An XML file 1201 is similar to the XML file 803, except the addition of an area 1202 describing a shortcut file path. The area 1202 includes a name of a shortcut generated by the bookbinding application 213 in step S705. The description of “C:YUsers/Desktop/(shortcut name)” in the area 1202 is an example of the shortcut name.

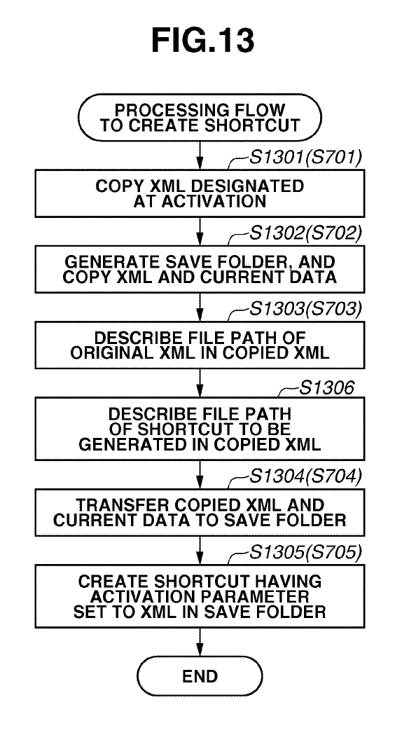

FIG. 13 is a flowchart illustrating creation of a shortcut. In the flowchart in FIG. 13, the steps similar to those in the first exemplary embodiment are given with the step numbers S701 to S705 respectively, which are not described below. In step S1306, the bookbinding application 213 adds description of shortcut file path to the XML file copied in step S1303 (step S703). The information is added to the area 1202 of the XML file in FIG. 12.

Through the processing in the flowchart in FIG. 13, the bookbinding application 213 generates the XML file 1201 in FIG. 12. The bookbinding application 213 can determine the shortcut corresponding to the XML file 1201 based on the contents in the area 1202.

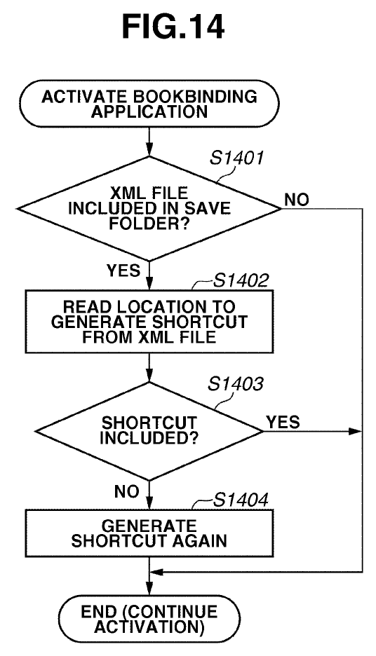

FIG. 14 is a flowchart illustrating recreation of a shortcut. The flowchart in FIG. 14 is executed by the bookbinding application 213 at the activation thereof. At the activation, in step S1401, the bookbinding application 213 refers to a save folder, and determines whether an XML file exists or not. The save folder is the one generated in step S1302, and if the shortcut is generated in the processing in the flowchart illustrated in FIG. 13, the folder contains the XML file. In step S1401, when no XML file exists in the save folder (NO in S1401), the bookbinding application 213 determines to terminate the operation. In this case, no shortcut is created by the bookbinding application 213, so that recreation of a shortcut is not necessary.

In step S1401 when the XML file exists in the save folder (YES in S1401), in step S1402, the bookbinding application 213 refers to the XML file found in step S1401 and reads the location to recreate the shortcut. The location for the shortcut is described in the area 1202 in FIG. 12. In step S1403, the bookbinding application 213 determines whether a shortcut exists at the location for the shortcut. In step S1403, if a shortcut exists (YES in step S1403), the flow ends. In this case, both of the shortcut and the XML file in the save folder exist, requiring no additional operation.

In step S1403, if no shortcut exits (NO in step S1403), the bookbinding application 213 advances the processing to step S1404. In this case, the XML exists in the save folder, but no corresponding shortcut exists. In step S1404, the bookbinding application 213 recreates the shortcut. The bookbinding application 213 follows the flowchart in FIG. 13 to recreate the shortcut.

As described above, in the second exemplary embodiment, if mismatching of a shortcut occurs due to deletion or relocation of the shortcut created by an application, the shortcut can be easily recreated because the XML file contains description of the location of the shortcut. Consequently, even when losing a shortcut of an application, a user can restart the application from the status at the interruption thereof.

When an application is interrupted in the middle of its operation, restart of the application by a user from the status at the point of interruption can be easily achieved by creating a shortcut using a parameter that enables activation of the application from the status at the point of interruption.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s) . For this purpose, the program is provided to the computer for example via a network or from a recording medium of various types serving as the memory device (e.g., computer-readable medium) .

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-113436 filed May 17, 2010, which is hereby incorporated by reference herein in its entirety.

What is claimed is:

1. An apparatus, comprising:
a storage unit configured to, if an instruction to interrupt an operation of a bookbinding application that sets print setting information is received, store operation contents of the bookbinding application at a point of interruption;
a creation unit configured to create a shortcut icon to reproduce the operation contents at the point of interruption; and
a reproduction unit configured to reproduce the operation contents at the point of interruption based on the stored operation contents at interruption, if the shortcut icon is designated.

2. The apparatus according to claim 1, further comprising:
a description unit configured to describe information designating a location where the shortcut icon is created in data required to activate the bookbinding application; and
a determination unit configured to read, at activation of the bookbinding application, the location of the shortcut icon from the data required to activate the bookbinding application, and to determine whether the shortcut exists at the read location,
wherein the creation unit creates the shortcut if the shortcut does not exist.

3. The apparatus according to claim 1, wherein the creation unit includes:
a copy unit configured to copy XML of the designated shortcut icon;
a generating unit configured to generate a save folder;
a transfer unit configured to transfer the copied XML and current data to the save folder; and
a shortcut creating unit having activation parameter configured to set to the copied XML in the save folder.

4. The apparatus according to claim 3, wherein the creation unit further includes:
a describing unit configured to describe a file path of an original XML in the copied XML and the file path of the shortcut to be generated in the copied XML.

5. The apparatus according to claim 1, further comprising an activation unit configured to activate the bookbinding application.

6. The apparatus according to claim 5, wherein the activation unit includes:
a determining unit configured to determine whether an XML file is included in a save folder and whether the shortcut is included in the XML file; and
a reader configured to read a location to generate the shortcut from the XML file.

7. A method comprising:
storing, if an instruction to interrupt an operation of a bookbinding application that sets print setting information is received, operation contents of the bookbinding application at the point of interruption;
creating a shortcut icon to reproduce the operation contents at the point of interruption; and
reproducing the operation contents at a point of interruption based on the stored operation contents at the point of interruption, if the created shortcut icon is designated.

8. The method according to claim 7, wherein the creating the short icon includes:
copying XML of the designated shortcut icon;
generating a save folder;
transferring the copied XML and current data to the save folder; and
creating shortcut having activation parameter set to the copied XML in the save folder.

9. The method according to claim 8, wherein the creating further comprises:
describing a file path of an original XML in the copied XML; and
describing the file path of the shortcut to be generated in the copied XML.

10. The method according to claim 7, further comprising activating the bookbinding application.

11. The method according to claim 10, wherein the activating includes:
determining whether an XML file is included in a save folder;
reading a location to generate the shortcut from the XML file; and
determining whether the shortcut is included in the XML file.

12. The method according to claim. 3, further comprising:
describing information designating a location where the shortcut icon is created in data required to activate the bookbinding application;
reading, at activation of the bookbinding application, the location of the shortcut icon from the data required to activate the bookbinding application, and determining whether the shortcut exists at the location; and
creating the shortcut if the shortcut does not exist.

13. A computer-readable storage medium storing a computer-executable program of instructions for causing a computer to perform a method comprising:
storing, if an instruction to interrupt an operation of a bookbinding application that sets print setting information is received, operation contents of the bookbinding application at the point of interruption;
creating a shortcut icon to reproduce the operation contents at the point of interruption; and
reproducing the operation contents at a point of interruption based on the stored operation contents at the point of interruption, if the created shortcut icon is designated.

14. The computer-readable storage medium according to claim 13 comprising:
describing information designating a location where the shortcut icon is created in data required to activate the bookbinding application;
reading, at activation of the bookbinding application, the location of the shortcut icon from the data required to activate the bookbinding application, and determining whether the shortcut exists at the location; and
creating the shortcut if the shortcut does not exist.

15. The computer-readable storage medium according to claim 14, wherein the creating the short icon includes:
copying XML of the designated shortcut icon;
generating a save folder;
transferring the copied XML and current data to the save folder; and
creating shortcut having activation parameter set to the copied XML in the save folder.

16. The computer-readable storage medium according to claim 15, wherein the creating further includes:
describing a file path of an original XML in the copied XML; and
describing the file path of the shortcut to be generated in the copied XML.

17. The computer-readable storage medium according to claim 13, further comprising activating the bookbinding application.

18. The computer-readable storage medium according to claim 17, wherein the activating includes:
determining whether an XML file is included in a save folder;
reading a location to generate the shortcut from the XML file; and
determining whether the shortcut is included in the XML file.
